(19) United States
(12) Patent Application Publication
(10) Pub. No.: US 2026/0269513 A1
(43) Pub. Date: Sep. 10, 2026

(54) Connector Assembly and Female Connector Thereof

(71) Applicants: Tarng Yu Enterprise co., ltd., New Taipei City (TW); Dongguan Tarng Yu Electronics Co., Ltd., Dongguan City (CN)

(72) Inventors: YING-CHUNG CHEN, New Taipei City (TW); MU-JUNG HUANG, New Taipei City (TW)

(21) Appl. No.: 19/558,468

(22) Filed: Mar. 6, 2026

(30) Foreign Application Priority Data
Mar. 7, 2025 (TW) 114202352

(51) Int. Cl. H01R 13/502; H01R 12/79

(52) U.S. Cl. CPC H01R 13/502; H01R 12/79

(57) ABSTRACT

A connector assembly and a female connector thereof are provided, wherein the female connector comprises a female metal cover and is coupled with a male connector of the connector assembly such that the male connector is inserted into the female connector, and subsequently, the female metal cover is configured to prevent the male connector from being disengaged from the female connector. Accordingly, the present disclosure addresses the technical problem in the prior art wherein the male connector is prone to detachment from the coupled female connector, thereby ensuring the expected signal transmission functionality of the connector assembly and allowing the connector assembly to be widely applied to various electronic devices for signal transmission.

### CROSS-REFERENCE TO RELATED APPLICATIONS

This application claims the priority of Republic of China Patent Application No. 114202352 filed on March 07, 2025, in the State Intellectual Property Office of the R.O.C., the disclosure of which is incorporated herein by reference.

### BACKGROUND OF THE INVENTION

### Field of the Invention

The present application relates to the technical field of electronic devices, and more particularly, to a connector assembly and a female connector thereof.

### Descriptions of the Related Art

In recent years, connector assemblies have been widely applied to various electronic devices. A connector assembly comprises a male connector and a female connector, wherein the male connector is coupled with the female connector for signal transmission.

However, with the trend toward thinner, lighter, and more compact electronic devices being growing, the internal space of such an electronic device has been significantly reduced, thereby forcing the size of the connector assembly used in the electronic device, as well as both the male and female connectors thereof, to be reduced. The size reduction may cause the male connector to become easily detached from the coupled female connector, thereby compromising the intended signal transmission functionality of the connector assembly.

In view of the foregoing, how to address the issue that the male connector is prone to detachment from the coupled female connector has become an urgent problem to be solved by those skilled in the art.

### SUMMARY OF THE INVENTION

In view of the drawbacks of the prior art mentioned above, the present application provides a female connector, comprising: a female insulation core, wherein one side of the female insulation core is a female major core side, the female insulation core comprises a female core body and a female major core sidewall, the female core body comprises a female core body coupling space, and the female major core sidewall is located at the female major core side; a female major metal shell installed on the female major core sidewall, wherein the female major metal shell comprises a female major shell guiding groove, and the female major shell guiding groove extends along a female major shell guiding path; and a female metal cover comprising a female cover body and a female major cover sidewall, wherein the female cover body comprises a female cover body opening-closing structure, the female major cover sidewall comprises a female major cover sidewall guiding structure, and the female metal cover spans across the female insulation core and the female major metal shell, such that the female major cover sidewall guiding structure is movable within the female major shell guiding groove along the female major shell guiding path to guide the female metal cover to move relative to the female insulation core, enabling the female cover body opening-closing structure to move to a female coupling space closed position and a female coupling space opened position; wherein, when the female cover body opening-closing structure moves to the female coupling space closed position, the female cover body opening-closing structure is configured to close the female core body coupling space; and when the female cover body opening-closing structure moves to the female coupling space opened position, the female cover body opening-closing structure is configured to open the female core body coupling space.

Preferably, the female connector said above further comprising a female coupling terminal, wherein the female insulation core is configured to position the female coupling terminal such that at least a portion of the female coupling terminal enters the female core body coupling space.

Preferably, the female connector said above, wherein the female major metal shell further comprises a female major shell opening limiting structure, and the female major shell opening limiting structure is located within the female major shell guiding groove, wherein, when the female cover body opening-closing structure moves to the female coupling space opened position, the female major shell opening limiting structure is configured to contact the female major cover sidewall guiding structure to limit a movement stroke of the female major cover sidewall guiding structure within the female major shell guiding groove.

Preferably, the female connector said above, wherein the female major shell opening limiting structure is a groove wall of the female major shell guiding groove; and the female major cover sidewall guiding structure is a resilient arm structure.

Preferably, the female connector said above, wherein another side of the female insulation core is a female minor core side, the female insulation core further comprises a female minor core sidewall, and the female minor core sidewall is located at the female minor core side; and the female connector further comprises: a female minor metal shell, wherein the female minor metal shell is installed on the female minor core sidewall, the female minor metal shell comprises a female minor shell guiding groove, and the female minor shell guiding groove extends along a female minor shell guiding path; the female metal cover further comprises a female minor cover sidewall, the female minor cover sidewall comprises a female minor cover sidewall guiding structure, and the female metal cover further spans across the female minor metal shell, such that the female minor cover sidewall guiding structure is movable within the female minor shell guiding groove along the female minor shell guiding path to guide the female metal cover to move relative to the female insulation core, enabling the female cover body opening-closing structure to move to the female coupling space closed position and the female coupling space opened position.

Preferably, the female connector said above, wherein the female minor metal shell further comprises a female minor shell opening limiting structure, and the female minor shell opening limiting structure is located within the female minor shell guiding groove, wherein, when the female cover body opening-closing structure moves to the female coupling space opened position, the female minor shell opening limiting structure is configured to contact the female minor cover sidewall guiding structure to limit a movement stroke of the female minor cover sidewall guiding structure within the female minor shell guiding groove.

Preferably, the female connector said above, wherein the female minor shell opening limiting structure is a groove wall of the female minor shell guiding groove, and the female minor cover sidewall guiding structure is a resilient arm structure.

Preferably, the female connector said above, wherein the female core body further comprises a female core body opening-closing stopper structure, and the female cover body further comprises a female cover body opening-closing stopper structure, wherein, when the female metal cover is moving relative to the female insulation core, the female metal cover is deformable under a force to allow the female cover body opening-closing stopper structure to cross over the female core body opening-closing stopper structure, and when the female cover body opening-closing structure moves to the female coupling space closed position or the female coupling space opened position, the female metal cover is releasable from deformation to allow the female cover body opening-closing stopper structure to contact the female core body opening-closing stopper structure to prevent the female cover body opening-closing structure from departing the female coupling space closed position or the female coupling space opened position.

Preferably, the female connector said above, wherein the female cover body opening-closing stopper structure is a protruding structure, and the female core body opening-closing stopper structure is a stopper wall structure.

Preferably, the female connector said above, wherein the female metal cover further comprises a female cover rear wall, and the female cover rear wall comprises a female cover rear wall closing limiting structure, wherein, when the female cover body opening-closing structure moves to the female coupling space closed position, the female cover rear wall closing limiting structure is configured to contact the female insulation core to limit a movement stroke of the female metal cover relative to the female insulation core.

Preferably, the female connector said above, wherein the female core body further comprises a female core body guiding structure, the female cover body further comprises a female cover body guiding groove, the female cover body guiding groove extends along a female cover guiding path, and the female core body guiding structure is movable within the female cover body guiding groove along the female cover guiding path to guide the female metal cover to move relative to the female insulation core, enabling the female cover body opening-closing structure to move to the female coupling space closed position and the female coupling space opened position.

Preferably, the female connector said above, wherein the female cover body further comprises a female cover body opening limiting structure and a female cover body closing limiting structure, and the female cover body opening limiting structure and the female cover body closing limiting structure are respectively located within the female cover body guiding groove, wherein, when the female cover body opening-closing structure moves to the female coupling space opened position, the female cover body opening limiting structure is configured to contact the female core body guiding structure to limit a movement stroke of the female core body guiding structure within the female cover body guiding groove; and when the female cover body opening-closing structure moves to the female coupling space closed position, the female cover body closing limiting structure is configured to contact the female core body guiding structure to limit a movement stroke of the female core body guiding structure within the female cover body guiding groove.

Preferably, the female connector said above, wherein the female cover body opening limiting structure and the female cover body closing limiting structure are groove walls of the female cover body guiding groove respectively, and the female core body guiding structure is a protrusion structure.

Additionally, the present application provides a connector assembly comprising: a male connector; and a female connector configured to be coupled with the male connector, wherein the female connector comprises: a female insulation core, wherein one side of the female insulation core is a female major core side, the female insulation core comprises a female core body and a female major core sidewall, the female core body comprises a female core body coupling space, and the female major core sidewall is located at the female major core side; a female major metal shell installed on the female major core sidewall, wherein the female major metal shell comprises a female major shell guiding groove, and the female major shell guiding groove extends along a female major shell guiding path; and a female metal cover comprising a female cover body and a female major cover sidewall, wherein the female cover body comprises a female cover body opening-closing structure, the female major cover sidewall comprises a female major cover sidewall guiding structure, and the female metal cover spans across the female insulation core and the female major metal shell such that the female major cover sidewall guiding structure is movable within the female major shell guiding groove along the female major shell guiding path to guide the female metal cover to move relative to the female insulation core, enabling the female cover body opening-closing structure to move to a female coupling space closed position and a female coupling space opened position; wherein, when the female cover body opening-closing structure moves to the female coupling space opened position, the female cover body opening-closing structure is configured to open the female core body coupling space to allow the male connector to access the female core body coupling space; and when the female cover body opening-closing structure moves to the female coupling space closed position, the female cover body opening-closing structure is configured to close the female core body coupling space to prevent the male connector from accessing the female core body coupling space.

Preferably, the connector assembly said above, wherein the male connector comprises a male coupling terminal, and the female connector comprises a female coupling terminal, when the female connector is engaged with the male connector, the male connector is enterable into the female core body coupling space, enabling the male coupling terminal to be electrically connected to the female coupling terminal.

Preferably, the connector assembly said above, wherein another side of the female insulation core is a female minor core side, the female insulation core further comprises a female minor core sidewall, and the female minor core sidewall is located at the female minor core side; and the female connector further comprises: a female minor metal shell, wherein the female minor metal shell is installed on the female minor core sidewall, the female minor metal shell comprises a female minor shell guiding groove, and the female minor shell guiding groove extends along a female minor shell guiding path; the female metal cover further comprises a female minor cover sidewall, the female minor cover sidewall comprises a female minor cover sidewall guiding structure, and the female metal cover further spans across the female minor metal shell such that the female minor cover sidewall guiding structure is movable within the female minor shell guiding groove along the female minor shell guiding path to guide the female metal cover to move relative to the female insulation core, enabling the female cover body opening-closing structure to move to the female coupling space closed position and the female coupling space opened position.

Compared to the prior art, the present application provides a connector assembly and a female connector thereof. The female connector comprises a female insulation core and a female metal cover, wherein the female connector is coupled with a male connector such that the male connector is allowed to enter the female insulation core. Thereafter, the female metal cover is able to prevent the male connector from leaving the female insulation core. Accordingly, the technical problems of the conventional male connector being easily detached from the coupled female connector can be solved, thereby ensuring that the signal transmission function of the connector assembly meets expectations, so that the connector assembly can be widely applied to various electronic devices.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective schematic view of a connector assembly of the present application in a first viewing angle of one embodiment.

FIG. 2 is a perspective schematic view of a connector assembly of the present application in a first viewing angle of one embodiment.

FIG. 3 is a perspective schematic view of a connector assembly of the present application in a second viewing angle of one embodiment.

FIG. 4 is a perspective schematic view of a connector assembly of the present application in a second viewing angle of one embodiment.

FIG. 5 is a top schematic view of a connector assembly of the present application in one embodiment.

FIG. 6 is a sectional schematic view of partial components of the connector assembly shown in FIG. 5, taken along line AA.

FIG. 7 is a side schematic view of a connector assembly of the present application in one embodiment.

FIG. 8 is a sectional schematic view of partial components of the connector assembly shown in FIG. 7, taken along line BB.

FIG. 9 is a rear schematic view of a connector assembly of the present application in one embodiment.

FIG. 10 is a sectional schematic view of partial components of the connector assembly shown in FIG. 9, taken along line CC.

FIG. 11 is a perspective schematic view of a connector assembly of the present application in a first viewing angle of one embodiment.

FIG. 12 is a perspective schematic view of a connector assembly of the present application in a second viewing angle of one embodiment.

FIG. 13 is a perspective schematic view of a female connector of the present application in a first viewing angle of one embodiment.

FIG. 14 is a perspective schematic view of a female connector of the present application in a second viewing angle of one embodiment.

FIG. 15 is a top schematic view of a connector assembly of the present application in one embodiment.

FIG. 16 is a sectional schematic view of partial components of the connector assembly shown in FIG. 15, taken along line DD.

FIG. 17 is a side schematic view of a connector assembly of the present application in one embodiment.

FIG. 18 is a sectional schematic view of partial components of the connector assembly shown in FIG. 17, taken along line EE.

FIG. 19 is a rear schematic view of a connector assembly of the present application in one embodiment.

FIG. 20 is a sectional schematic view of partial components of the connector assembly shown in FIG. 19, taken along line FF.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

The present application provides a connector assembly and a female connector thereof. The female connector comprises a female metal cover and is coupled with a male connector such that the male connector is inserted into the female connector. Subsequently, the female metal cover is capable of preventing the male connector from disengaging from the female connector. Therefore, the present application can address the technical problem in the prior art where the male connector is prone to detachment from the coupled female connector, thereby ensuring the expected signal transmission functionality of the connector assembly and allowing the connector assembly to be widely applied in various electronic devices for signal transmission.

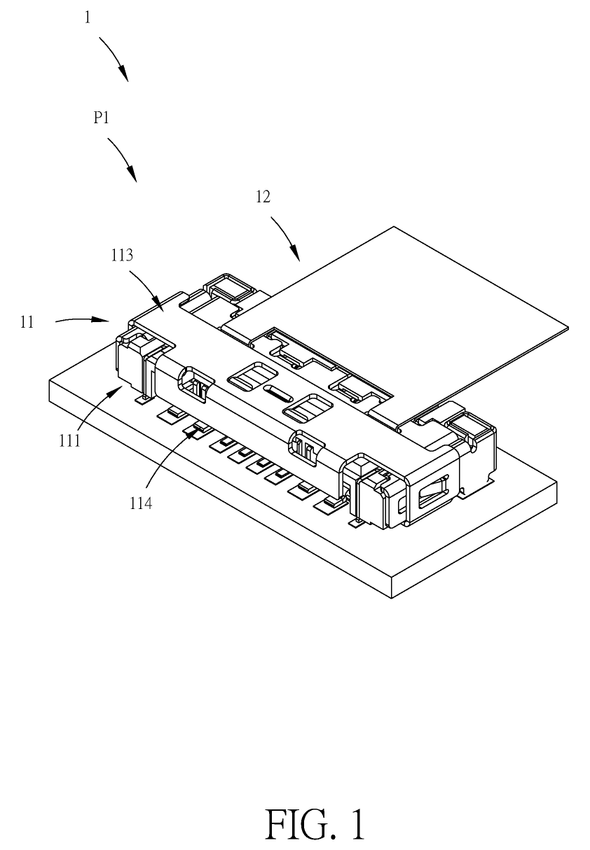

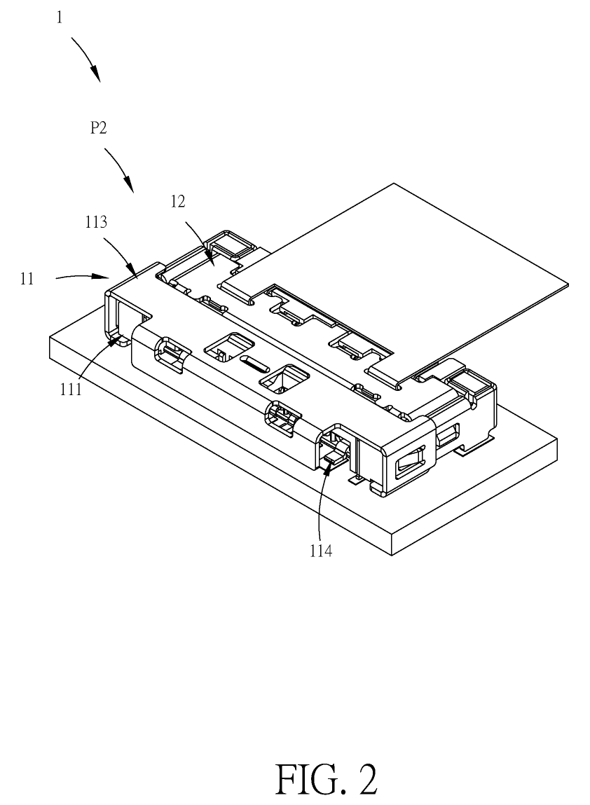

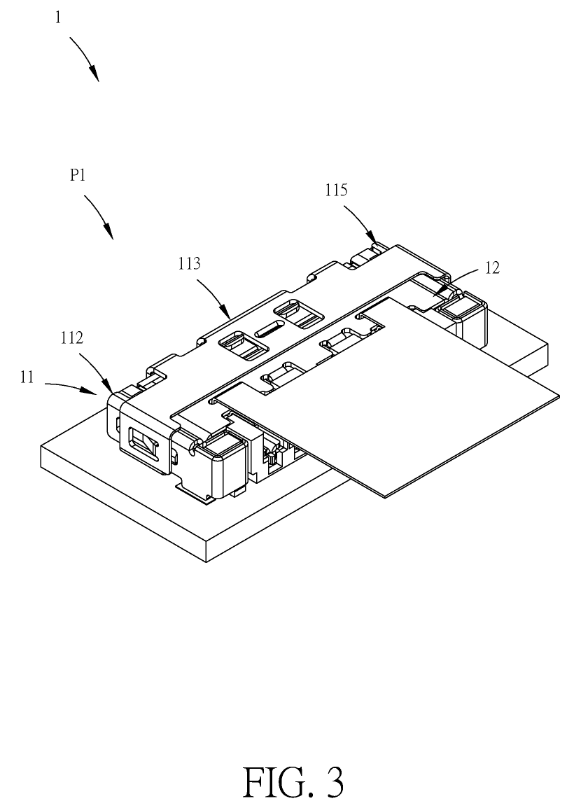

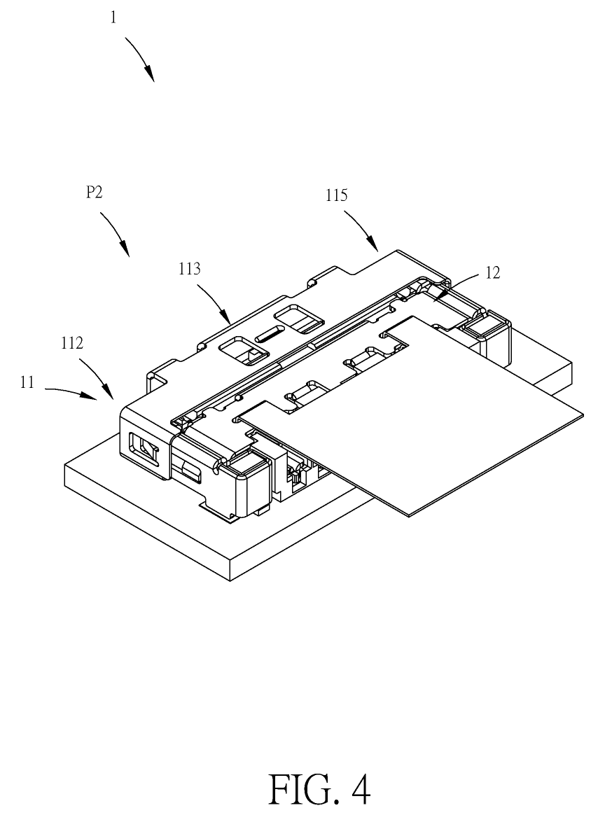

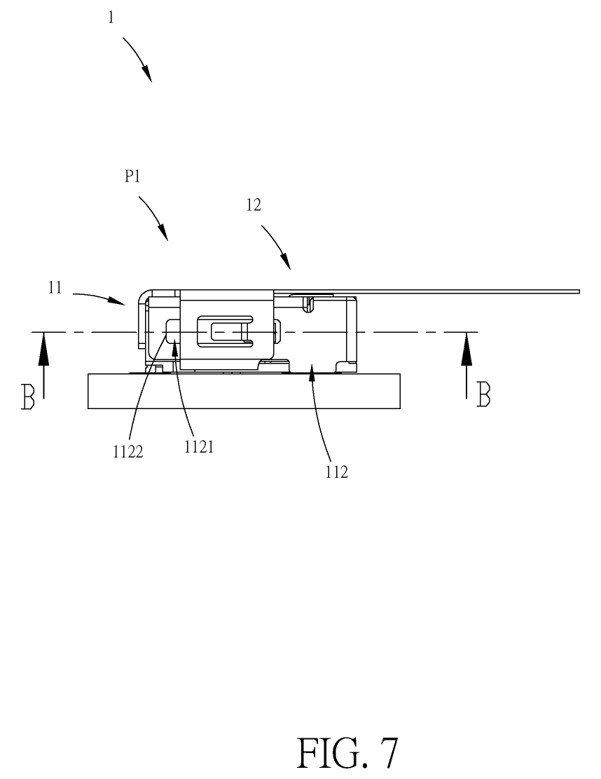

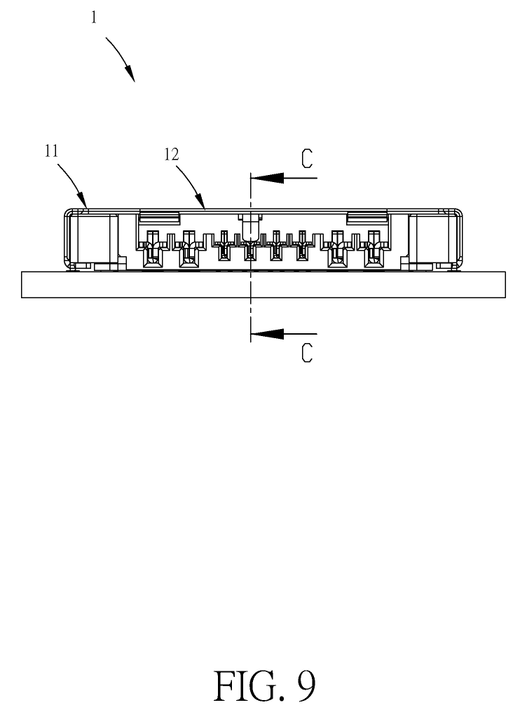

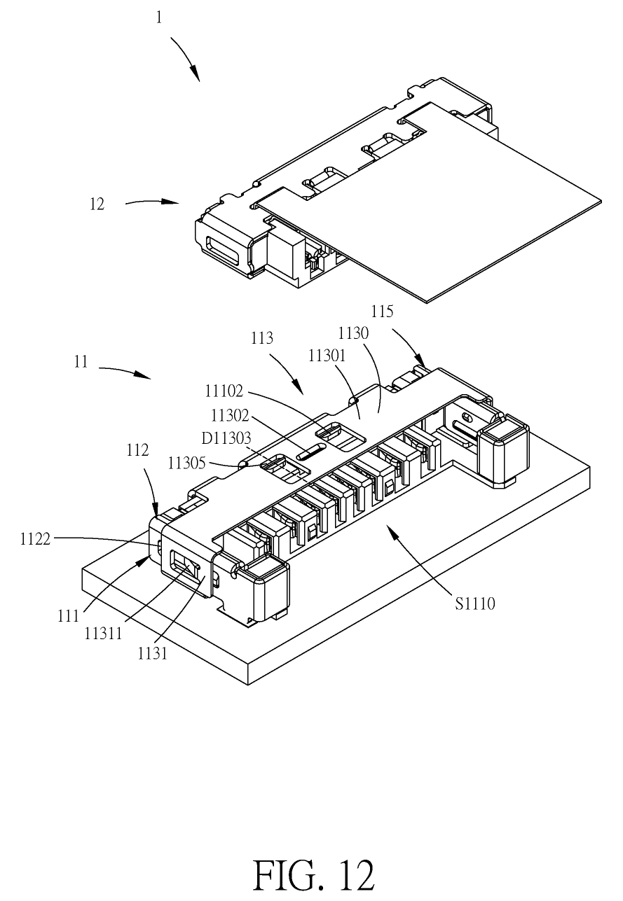

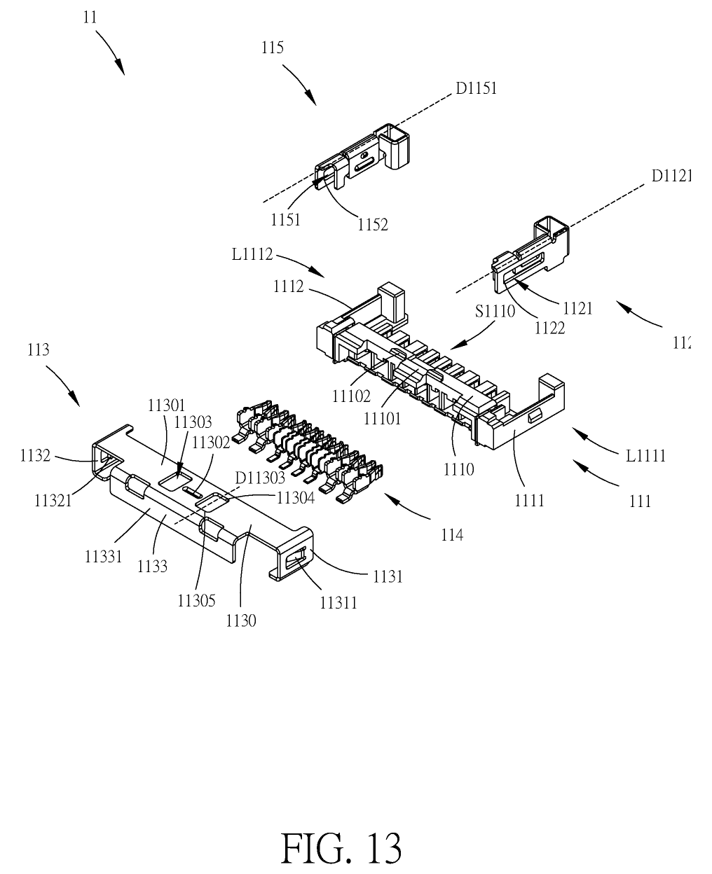

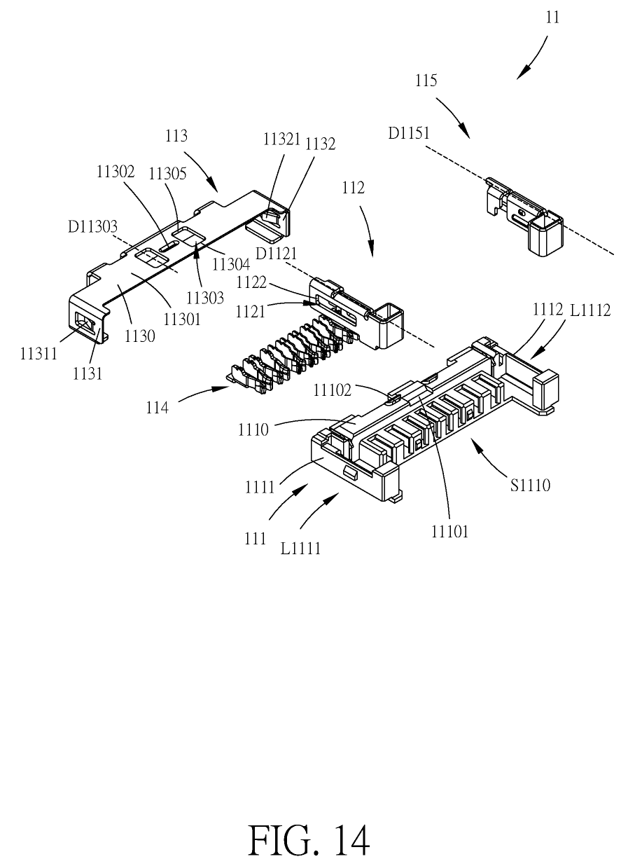

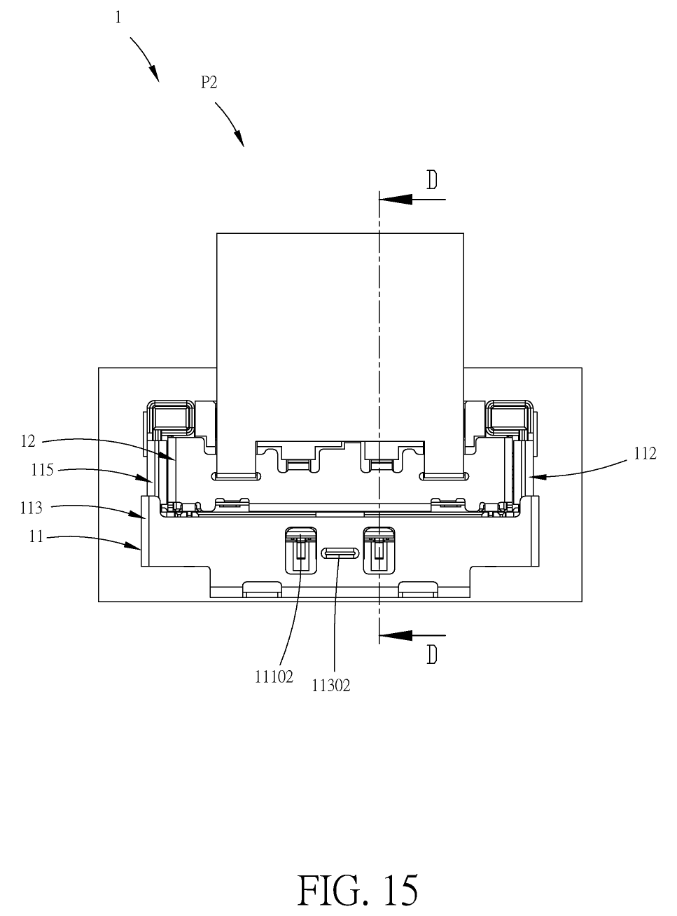

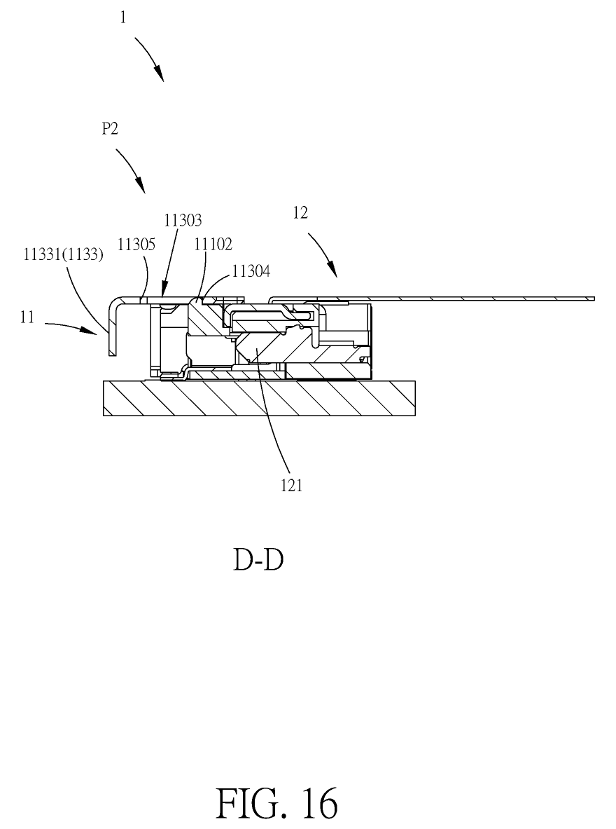

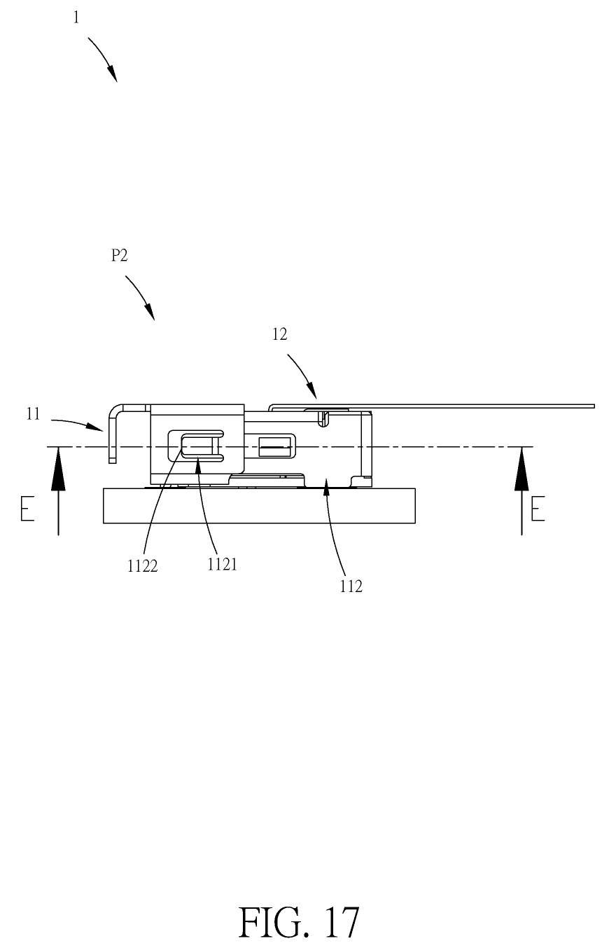

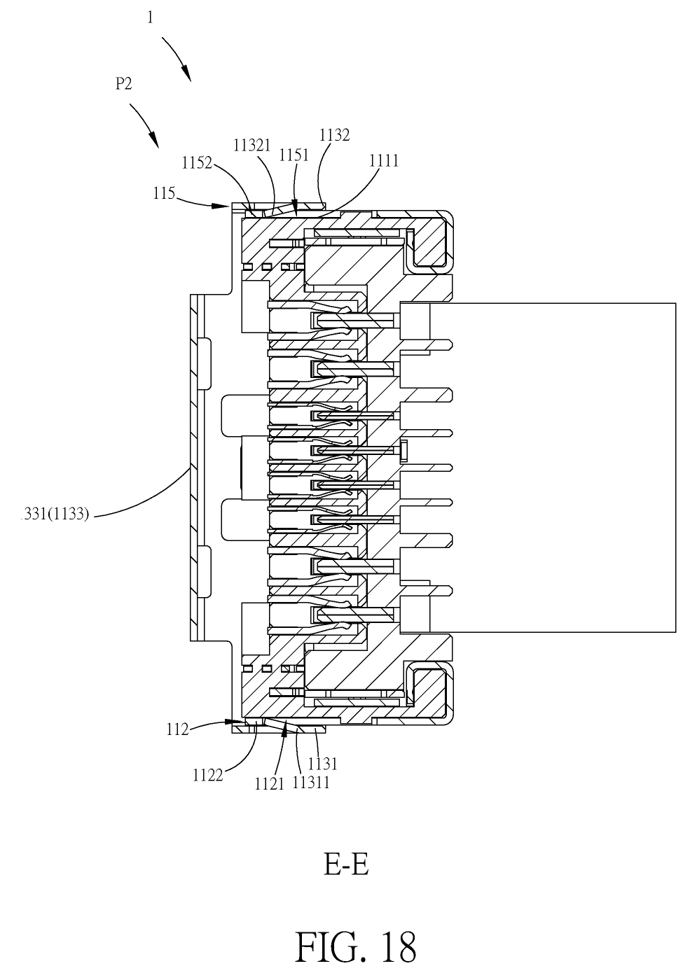

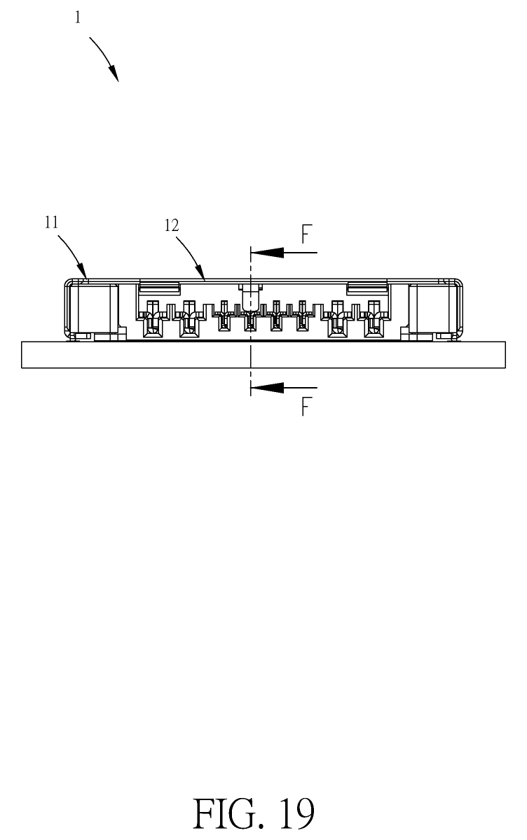

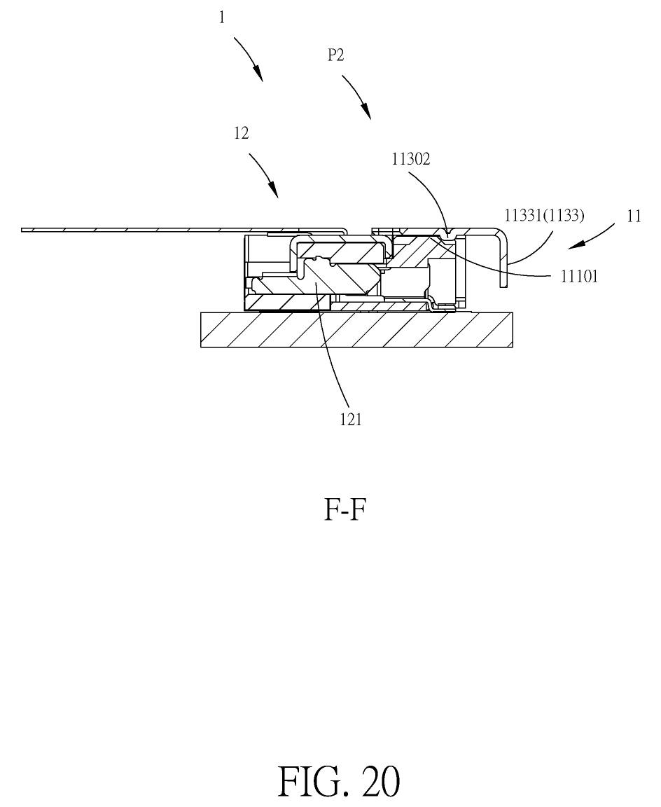

For a detailed description of the embodiments disclosed in the present application, please refer to FIGS. 1 to 20.

In the embodiments shown in FIGS. 1 to 20, the connector assembly 1 comprises a male connector 12 and a female connector 11. The male connector 12 is coupled with the female connector 11 to transmit signals in various electronic devices.

The male connector 12 comprises at least one male coupling terminal 121.

The female connector 11 comprises at least one female insulation core 111, at least one female major metal shell 112, at least one female metal cover 113, at least one female coupling terminal 114, and at least one female minor metal shell 115.

The female insulation core 111 has two sides respectively defined as a female major core side L1111 and a female minor core side L1112. The female insulation core 111 comprises a female core body 1110, a female major core sidewall 1111, and a female minor core sidewall 1112. The female core body 1110 comprises a female core body coupling space S1110. The female major core sidewall 1111 is located at the female major core side L1111. The female minor core sidewall 1112 is located at the female minor core side L1112. The female insulation core 111 is configured to position the female coupling terminal 114 such that at least a portion of the female coupling terminal 114 enters the female core body coupling space S1110 to enable coupling with the male coupling terminal 121 and achieve signal transmission.

The female major metal shell 112 installed on the female major core sidewall 1111 and is installed on the female major core sidewall 1111 at the female major core side L1111. The female major metal shell 112 comprises a female major shell guiding groove 1121 and a female major shell opening limiting structure 1122. In this embodiment, the female major shell guiding groove 1121 extends along a female major shell guiding path D1121, and the female major shell opening limiting structure 1122 is a groove wall of the female major shell guiding groove 1121 and is located therein.

The female minor metal shell 115 is installed on the female minor core sidewall 1112 and is engaged with the female minor core sidewall 1112 at the female minor core side L1112. The female minor metal shell 115 comprises a female minor shell guiding groove 1151 and a female minor shell opening limiting structure 1152. In this embodiment, the female minor shell guiding groove 1151 extends along a female minor shell guiding path D1151, and the female minor shell opening limiting structure 1152 is a groove wall of the female minor shell guiding groove 1151 and is located therein.

The female metal cover 113 comprises a female cover body 1130, a female major cover sidewall 1131, a female minor cover sidewall 1132, and a female cover rear wall 1133. The female major cover sidewall 1131 and the female minor cover sidewall 1132 are respectively located at two sides of the female cover body 1130. The female cover rear wall 1133 is located at the rear end of the female cover body 1130.

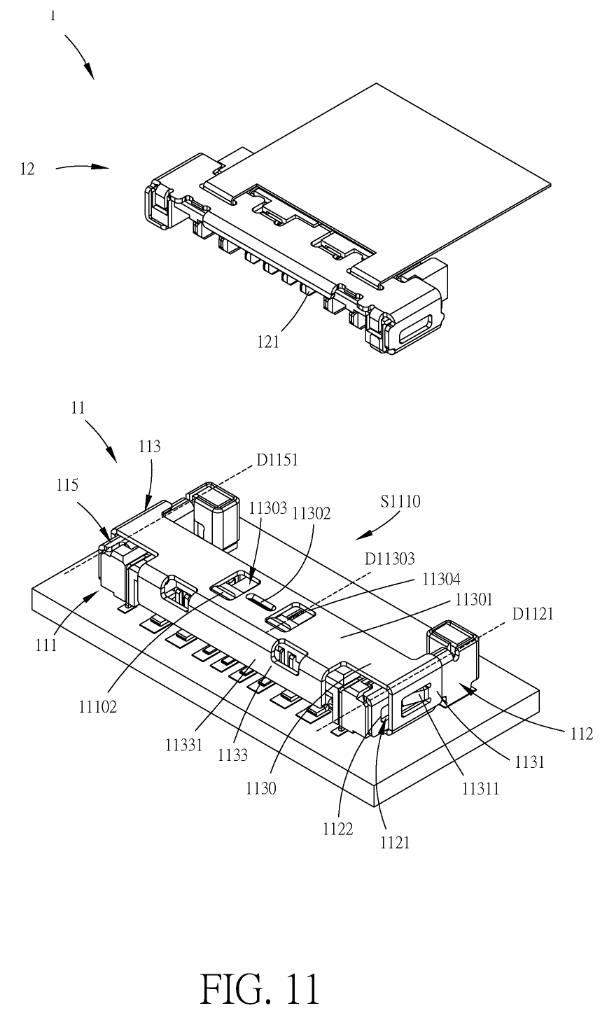

In the embodiments shown in FIGS. 11 to 14, the female cover body 1130 comprises a female cover body opening-closing structure 11301. The female major cover sidewall 1131 comprises a female major cover sidewall guiding structure 11311. The female minor cover sidewall 1132 comprises a female minor cover sidewall guiding structure 11321. The female cover rear wall 1133 comprises a female cover rear wall closing limiting structure 11331.

In the above embodiment, the female metal cover 113 spans across the female insulation core 111, the female major metal shell 112, and the female minor metal shell 115 such that the female major cover sidewall guiding structure 11311 is movable within the female major shell guiding groove 1121 along the female major shell guiding path D1121, and the female minor cover sidewall guiding structure 11321 is movable within the female minor shell guiding groove 1151 along the female minor shell guiding path D1151, thereby guiding the female metal cover 113 to move relative to the female insulation core 111, and enabling the female cover body opening-closing structure 11301 to move to a female coupling space closed position P1 and a female coupling space opened position P2.

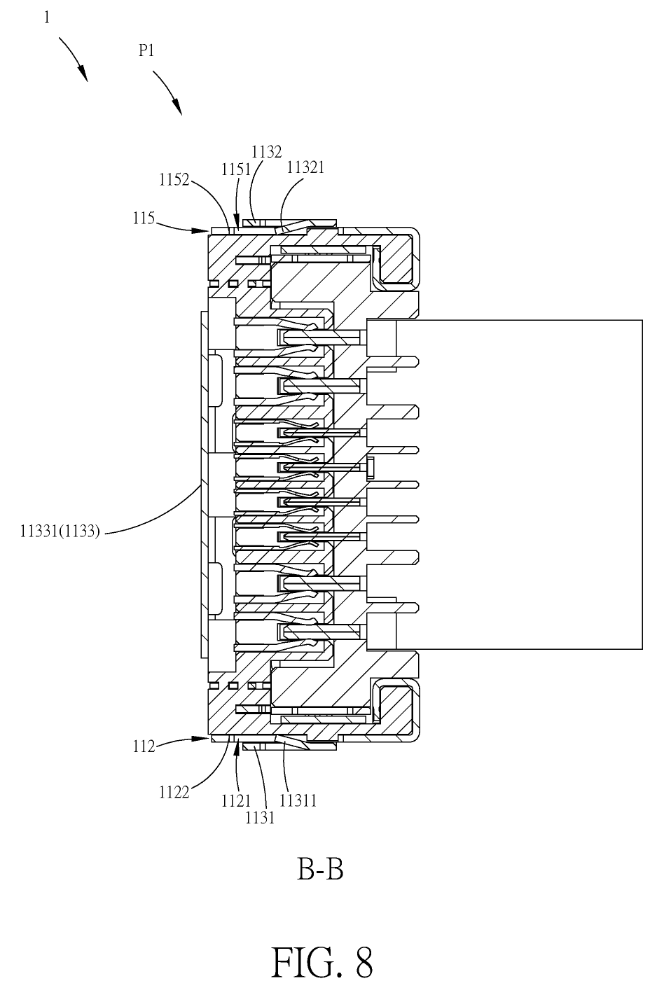

In the embodiments shown in FIGS. 8 and 11 to 14, the female major cover sidewall guiding structure 11311 is a resilient arm structure, such that it elastically abuts the female major core sidewall 1111. This ensures that the female major cover sidewall guiding structure 11311 continuously guides the female metal cover 113 to move relative to the female insulation core 111. In addition, the female minor cover sidewall guiding structure 11321 is a resilient arm structure, such that it elastically abuts the female major core sidewall 1111. This ensures that the female major cover sidewall guiding structure 11311 guides the female metal cover 113 to move relative to the female insulation core 111.

It should be noted that when the female cover body opening-closing structure 11301 moves to the female coupling space opened position P2, it opens the female core body coupling space S1110 such that the male connector 12 can access the female core body coupling space S1110, i.e., the male connector 12 can enter or exit the female connector 11. When the male connector 12 enters the female core body coupling space S1110, the female connector 11 engages the male connector 12 such that the female coupling terminal 114 is electrically connected to the male coupling terminal 121 to transmit signals.

In this embodiment, when the female cover body opening-closing structure 11301 moves to the female coupling space opened position P2, the female major shell opening limiting structure 1122 contacts the female major cover sidewall guiding structure 11311 to limit the movement stroke of the female major cover sidewall guiding structure 11311 within the female major shell guiding groove 1121, thereby preventing the female cover body opening-closing structure 11301 from easily departing from the female coupling space opened position P2. Additionally, when the female cover body opening-closing structure 11301 moves to the female coupling space opened position P2, the female minor shell opening limiting structure 1152 contacts the female minor cover sidewall guiding structure 11321 to limit the movement stroke of the female minor cover sidewall guiding structure 11321 within the female minor shell guiding groove 1151, thereby preventing the female cover body opening-closing structure 11301 from easily departing from the female coupling space opened position P2.

When the female cover body opening-closing structure 11301 moves to the female coupling space closed position P1, it closes the female core body coupling space S1110 to prevent the male connector 12 from accessing the female core body coupling space S1110, i.e., the male connector 12 cannot enter or exit the female connector 11. Therefore, when the female cover body opening-closing structure 11301 closes the female core body coupling space S1110, the female metal cover 113 is capable of preventing the male connector 12 from departing from the female connector 11, thereby maintaining the engagement of the female connector 11 with the male connector 12. As such, the present application can address the technical problem in the prior art where the male connector is prone to detachment from the coupled female connector, thereby ensuring the expected signal transmission functionality of the connector assembly and allowing the connector assembly to be widely applied in various electronic devices for signal transmission.

Additionally, when the female cover body opening-closing structure 11301 moves to the female coupling space closed position P1, the female cover rear wall closing limiting structure 11331 is configured to contact the female insulation core 111 to limit the movement stroke of the female metal cover 113 relative to the female insulation core 111, thereby preventing the female cover body opening-closing structure 11301 from easily departing from the female coupling space closed position P1.

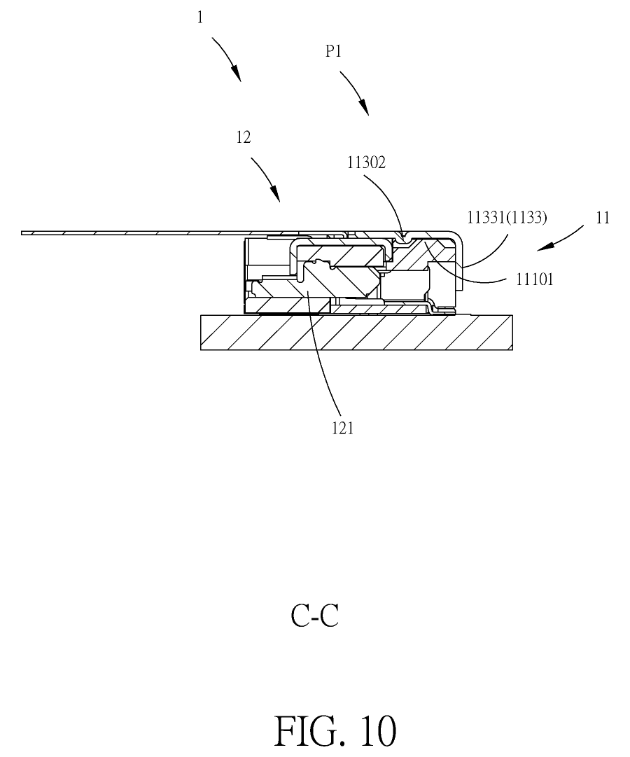

In the embodiments shown in FIGS. 10, 13 to 14, and 20, of the present application, the female core body 1110 further comprises a female core body opening-closing stopper structure 11101, and the female cover body 1130 further comprises a female cover body opening-closing stopper structure 11302. Optionally, the female cover body opening-closing stopper structure 11302 is a protruding structure, and correspondingly, the female core body opening-closing stopper structure 11101 is a stopper wall structure. This allows for reduction in the size of the female connector 11, thereby enabling electronic devices that adopt the connector assembly 1 and the female connector 11 to continue developing toward miniaturization and compactness.

It should be noted that when the female metal cover 113 moves relative to the female insulation core 111, the female metal cover 113 is deformable under force such that the female cover body opening-closing stopper structure 11302 crosses over the female core body opening-closing stopper structure 11101. Additionally, when the female cover body opening-closing structure 11301 moves to the female coupling space closed position P1 or the female coupling space opened position P2, the female metal cover 113 is releasable from deformation to allow the female cover body opening-closing stopper structure 11302 to contact the female core body opening-closing stopper structure 11101 to restrict the female cover body opening-closing structure 11301 from departing from the female coupling space closed position P1 or the female coupling space opened position P2. This prevents the female cover body opening-closing structure 11301 from easily departing from the female coupling space closed position P1, addressing the prior art issue where the male connector is prone to detachment from the coupled female connector. Furthermore, it also prevents the female cover body opening-closing structure 11301 from easily departing from the female coupling space opened position P2, thereby preventing the female cover body opening-closing structure 11301 from unintentionally interfering with the access of the male connector 12 into or out of the female core body coupling space S1110.

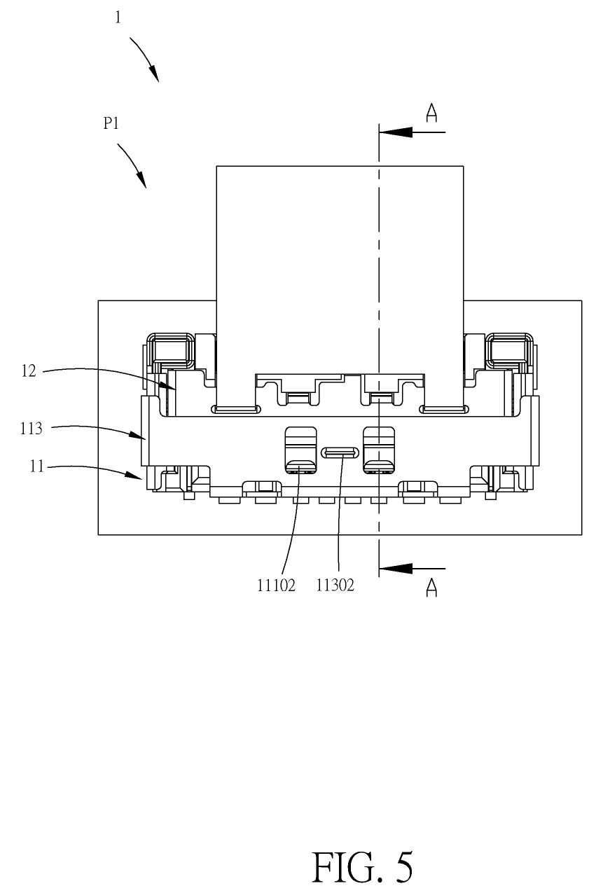

In the embodiments shown in FIGS. 5 to 6 and 11 to 16 of the present application, the female core body 1110 further comprises a female core body guiding structure 11102. Correspondingly, the female cover body 1130 comprises a female cover body guiding groove 11303, a female cover body opening limiting structure 11304, and a female cover body closing limiting structure 11305. The female cover body guiding groove 11303 extends along a female cover guiding path D11303. Correspondingly, the female core body guiding structure 11102 is movable within the female cover body guiding groove 11303 along the female cover guiding path D11303 to guide the female metal cover 113 to move relative to the female insulation core 111, enabling the female cover body opening-closing structure 11301 to move to the female coupling space closed position P1 and the female coupling space opened position P2. The female cover body opening limiting structure 11304 and the female cover body closing limiting structure 11305 are respectively located within the female cover body guiding groove 11303.

It should be noted that when the female cover body opening-closing structure 11301 moves to the female coupling space opened position P2, the female cover body opening limiting structure 11304 is configured to contact the female core body guiding structure 11102 to limit the movement stroke of the female core body guiding structure 11102 within the female cover body guiding groove 11303, thereby preventing the female cover body opening-closing structure 11301 from easily departing from the female coupling space opened position P2. Additionally, when the female cover body opening-closing structure 11301 moves to the female coupling space closed position P1, the female cover body closing limiting structure 11305 is configured to contact the female core body guiding structure 11102 to limit the movement stroke of the female core body guiding structure 11102 within the female cover body guiding groove 11303, thereby preventing the female cover body opening-closing structure 11301 from easily departing from the female coupling space closed position P1.

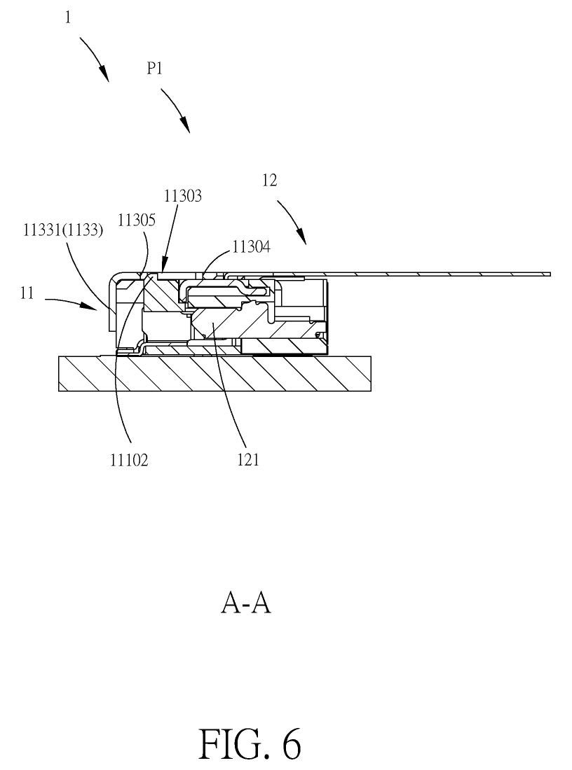

In the embodiments shown in FIGS. 6, 13 to 14, and 16, the female cover body opening limiting structure 11304 and the female cover body closing limiting structure 11305 are groove walls of the female cover body guiding groove 11303. Correspondingly, the female core body guiding structure 11102 is a protrusion structure.

It should be noted that the connector assembly and the female connector of the present application may omit certain components and are not limited to the above-described embodiments.

For example, the female connector of the present application may optionally comprise: a female insulation core, a female major metal shell, and a female metal cover. One side of the female insulation core is a female major core side. The female insulation core comprises a female core body and a female major core sidewall. The female core body comprises a female core body coupling space, and the female major core sidewall is located at the female major core side. The female major metal shell installed on the female major core sidewall and comprises a female major shell guiding groove. The female major shell guiding groove extends along a female major shell guiding path. The female metal cover comprises a female cover body and a female major cover sidewall. The female cover body comprises a female cover body opening-closing structure, and the female major cover sidewall comprises a female major cover sidewall guiding structure. The female metal cover spans across the female insulation core and the female major metal shell such that the female major cover sidewall guiding structure is movable within the female major shell guiding groove along the female major shell guiding path to guide the female metal cover to move relative to the female insulation core, thereby enabling the female cover body opening-closing structure to move to the female coupling space closed position and the female coupling space opened position; wherein, when the female cover body opening-closing structure moves to the female coupling space closed position, it is configured to close the female core body coupling space; and when the female cover body opening-closing structure moves to the female coupling space opened position, it is configured to open the female core body coupling space.

Furthermore, the connector assembly of the present application may optionally comprise: a male connector and a female connector. The female connector is coupled with the male connector and comprises: a female insulation core, a female major metal shell, and a female metal cover. One side of the female insulation core is a female major core side. The female insulation core comprises a female core body and a female major core sidewall. The female core body comprises a female core body coupling space, and the female major core sidewall is located at the female major core side. The female major metal shell installed on the female major core sidewall and comprises a female major shell guiding groove. The female major shell guiding groove extends along a female major shell guiding path. The female metal cover comprises a female cover body and a female major cover sidewall. The female cover body comprises a female cover body opening-closing structure, and the female major cover sidewall comprises a female major cover sidewall guiding structure. The female metal cover spans across the female insulation core and the female major metal shell such that the female major cover sidewall guiding structure is movable within the female major shell guiding groove along the female major shell guiding path to guide the female metal cover to move relative to the female insulation core, enabling the female cover body opening-closing structure to move to the female coupling space closed position and the female coupling space opened position; wherein, when the female cover body opening-closing structure moves to the female coupling space opened position, it is configured to open the female core body coupling space to allow the male connector to access the female core body coupling space; and when the female cover body opening-closing structure moves to the female coupling space closed position, it is configured to close the female core body coupling space to prevent the male connector from accessing the female core body coupling space.

In summary, the present application provides a connector assembly and a female connector thereof. The female connector comprises a female insulation core and a female metal cover and is coupled with a male connector such that the male connector is inserted into the female insulation core. Subsequently, the female metal cover is capable of preventing the male connector from disengaging from the female insulation core. Therefore, the present application can address the technical problem in the prior art where the male connector is prone to detachment from the coupled female connector, thereby ensuring the expected signal transmission functionality of the connector assembly and allowing the connector assembly to be widely applied in various electronic devices for signal transmission.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. A female connector comprising:
a female insulation core, wherein one side of the female insulation core is a female major core side, the female insulation core comprises a female core body and a female major core sidewall, the female core body comprises a female core body coupling space, and the female major core sidewall is located at the female major core side;
a female major metal shell installed on the female major core sidewall, wherein the female major metal shell comprises a female major shell guiding groove, and the female major shell guiding groove extends along a female major shell guiding path; and
a female metal cover comprising a female cover body and a female major cover sidewall, wherein the female cover body comprises a female cover body opening-closing structure, the female major cover sidewall comprises a female major cover sidewall guiding structure, and the female metal cover spans across the female insulation core and the female major metal shell, such that the female major cover sidewall guiding structure is movable within the female major shell guiding groove along the female major shell guiding path to guide the female metal cover to move relative to the female insulation core, enabling the female cover body opening-closing structure to move to a female coupling space closed position and a female coupling space opened position; wherein,
when the female cover body opening-closing structure moves to the female coupling space closed position, the female cover body opening-closing structure is configured to close the female core body coupling space; and
when the female cover body opening-closing structure moves to the female coupling space opened position, the female cover body opening-closing structure is configured to open the female core body coupling space.

2. The female connector of claim 1 further comprising a female coupling terminal, wherein the female insulation core is configured to position the female coupling terminal such that at least a portion of the female coupling terminal enters the female core body coupling space.

3. The female connector of claim 1, wherein the female major metal shell further comprises a female major shell opening limiting structure, and the female major shell opening limiting structure is located within the female major shell guiding groove, wherein, when the female cover body opening-closing structure moves to the female coupling space opened position, the female major shell opening limiting structure is configured to contact the female major cover sidewall guiding structure to limit a movement stroke of the female major cover sidewall guiding structure within the female major shell guiding groove.

4. The female connector of claim 3, wherein the female major shell opening limiting structure is a groove wall of the female major shell guiding groove; and the female major cover sidewall guiding structure is a resilient arm structure.

5. The female connector of claim 1, wherein another side of the female insulation core is a female minor core side, the female insulation core further comprises a female minor core sidewall, and the female minor core sidewall is located at the female minor core side; and the female connector further comprises: a female minor metal shell, wherein the female minor metal shell is installed on the female minor core sidewall, the female minor metal shell comprises a female minor shell guiding groove, and the female minor shell guiding groove extends along a female minor shell guiding path; the female metal cover further comprises a female minor cover sidewall, the female minor cover sidewall comprises a female minor cover sidewall guiding structure, and the female metal cover further spans across the female minor metal shell, such that the female minor cover sidewall guiding structure is movable within the female minor shell guiding groove along the female minor shell guiding path to guide the female metal cover to move relative to the female insulation core, enabling the female cover body opening-closing structure to move to the female coupling space closed position and the female coupling space opened position.

6. The female connector of claim 5, wherein the female minor metal shell further comprises a female minor shell opening limiting structure, and the female minor shell opening limiting structure is located within the female minor shell guiding groove, wherein, when the female cover body opening-closing structure moves to the female coupling space opened position, the female minor shell opening limiting structure is configured to contact the female minor cover sidewall guiding structure to limit a movement stroke of the female minor cover sidewall guiding structure within the female minor shell guiding groove.

7. The female connector of claim 6, wherein the female minor shell opening limiting structure is a groove wall of the female minor shell guiding groove, and the female minor cover sidewall guiding structure is a resilient arm structure.

8. The female connector of claim 1, wherein the female core body further comprises a female core body opening-closing stopper structure, and the female cover body further comprises a female cover body opening-closing stopper structure, wherein, when the female metal cover is moving relative to the female insulation core, the female metal cover is deformable under a force to allow the female cover body opening-closing stopper structure to cross over the female core body opening-closing stopper structure, and when the female cover body opening-closing structure moves to the female coupling space closed position or the female coupling space opened position, the female metal cover is releasable from deformation to allow the female cover body opening-closing stopper structure to contact the female core body opening-closing stopper structure to prevent the female cover body opening-closing structure from departing the female coupling space closed position or the female coupling space opened position.

9. The female connector of claim 8, wherein the female cover body opening-closing stopper structure is a protruding structure, and the female core body opening-closing stopper structure is a stopper wall structure.

10. The female connector of claim 1, wherein the female metal cover further comprises a female cover rear wall, and the female cover rear wall comprises a female cover rear wall closing limiting structure, wherein, when the female cover body opening-closing structure moves to the female coupling space closed position, the female cover rear wall closing limiting structure is configured to contact the female insulation core to limit a movement stroke of the female metal cover relative to the female insulation core.

11. The female connector of claim 1, wherein the female core body further comprises a female core body guiding structure, the female cover body further comprises a female cover body guiding groove, the female cover body guiding groove extends along a female cover guiding path, and the female core body guiding structure is movable within the female cover body guiding groove along the female cover guiding path to guide the female metal cover to move relative to the female insulation core, enabling the female cover body opening-closing structure to move to the female coupling space closed position and the female coupling space opened position.

12. The female connector of claim 11, wherein the female cover body further comprises a female cover body opening limiting structure and a female cover body closing limiting structure, and the female cover body opening limiting structure and the female cover body closing limiting structure are respectively located within the female cover body guiding groove, wherein, when the female cover body opening-closing structure moves to the female coupling space opened position, the female cover body opening limiting structure is configured to contact the female core body guiding structure to limit a movement stroke of the female core body guiding structure within the female cover body guiding groove; and when the female cover body opening-closing structure moves to the female coupling space closed position, the female cover body closing limiting structure is configured to contact the female core body guiding structure to limit a movement stroke of the female core body guiding structure within the female cover body guiding groove.

13. The female connector of claim 12, wherein the female cover body opening limiting structure and the female cover body closing limiting structure are groove walls of the female cover body guiding groove respectively, and the female core body guiding structure is a protrusion structure.

14. A connector assembly comprising:
a male connector; and
a female connector configured to be coupled with the male connector, wherein the female connector comprises:
a female insulation core, wherein one side of the female insulation core is a female major core side, the female insulation core comprises a female core body and a female major core sidewall, the female core body comprises a female core body coupling space, and the female major core sidewall is located at the female major core side;
a female major metal shell installed on the female major core sidewall, wherein the female major metal shell comprises a female major shell guiding groove, and the female major shell guiding groove extends along a female major shell guiding path; and
a female metal cover comprising a female cover body and a female major cover sidewall, wherein the female cover body comprises a female cover body opening-closing structure, the female major cover sidewall comprises a female major cover sidewall guiding structure, and the female metal cover spans across the female insulation core and the female major metal shell such that the female major cover sidewall guiding structure is movable within the female major shell guiding groove along the female major shell guiding path to guide the female metal cover to move relative to the female insulation core, enabling the female cover body opening-closing structure to move to a female coupling space closed position and a female coupling space opened position; wherein,
when the female cover body opening-closing structure moves to the female coupling space opened position, the female cover body opening-closing structure is configured to open the female core body coupling space to allow the male connector to access the female core body coupling space; and
when the female cover body opening-closing structure moves to the female coupling space closed position, the female cover body opening-closing structure is configured to close the female core body coupling space to prevent the male connector from accessing the female core body coupling space.

15. The connector assembly of claim 14, wherein the male connector comprises a male coupling terminal, and the female connector comprises a female coupling terminal, when the female connector is engaged with the male connector, the male connector is enterable into the female core body coupling space, enabling the male coupling terminal to be electrically connected to the female coupling terminal.

16. The connector assembly of claim 14, wherein another side of the female insulation core is a female minor core side, the female insulation core further comprises a female minor core sidewall, and the female minor core sidewall is located at the female minor core side; and the female connector further comprises: a female minor metal shell, wherein the female minor metal shell is installed on the female minor core sidewall, the female minor metal shell comprises a female minor shell guiding groove, and the female minor shell guiding groove extends along a female minor shell guiding path; the female metal cover further comprises a female minor cover sidewall, the female minor cover sidewall comprises a female minor cover sidewall guiding structure, and the female metal cover further spans across the female minor metal shell such that the female minor cover sidewall guiding structure is movable within the female minor shell guiding groove along the female minor shell guiding path to guide the female metal cover to move relative to the female insulation core, enabling the female cover body opening-closing structure to move to the female coupling space closed position and the female coupling space opened position.
